(19) United States
(12) Patent Application Publication
(10) Pub. No.: US 2004/0243724 A1
(43) Pub. Date: Dec. 2, 2004

(54) Combined position and torque sensor

(76) Inventor: Bernd Gombert, Seefeld (DE)

Correspondence Address: Leopold Presser, Scully Scott Murphy & Presser, 400 Garden City Plaza, Garden City, NY, 11530, US

(21) Appl. No.: 10/433,360

(22) PCT Filed: Sep. 18, 2002
(86) PCT No.: PCT/EP02/10473

(30) Foreign Application Priority Data
Sep. 21, 2001 (DE) 10146473.8

(51) Int. Cl. G06F 3/00

(52) U.S. Cl. 710/1

(57) ABSTRACT

An input device (4) for driving computers, electronic or electrical devices has a two-dimensional position sensor (1) and a force and moment sensor (2) which detects forces and torques acting on an operating part (5) of the force and moment sensor (2). By manual manipulation of the input device (4) drive signals can be triggered by the two-dimensional position sensor (1) and/or the force and moment sensor (2).

The present invention relates to an input device in which a position sensor is combined with a force and moment sensor.

The general background of the present invention is the driving of real or virtual objects, such as, for example, computers, electronic or electrical devices, wherein the drive signals are triggered by position sensors or force and moment sensors. A position sensor is a device which detects the position and/or the relative movement of the device in respect of a reference point. A force and moment sensor is a device which detects and evaluates the forces and torques acting on an operating part of the force and moment sensor.

As according to the invention there is recourse to the technology basically known for position sensors and force and moment sensors, the prior art in respect of position and force and moment sensors will be briefly explained below.

Input devices with position sensors which generate drive signals for virtual or real objects depending on the position of the input device and, to be more precise, depending on the relative movement of the input device in respect of a base or a carrier, are known from the prior art. They allow intuitive and interactive checking of a cursor on a display screen surface, for example. Examples of position input devices of this kind are the computer mouse, the touchpad and the trackball. The computer mouse is the most widespread input device. Among its basic features are the housing with a planar base and a structure which allows operation with one hand, one or more buttons on the upper side, equipment for detecting the movement on the underside and a cable or an air interface for data transmission to a computer.

With position input devices of this kind detecting movement in respect of the base or in respect of a carrier can take place, e.g.

mechanically (here, for example, the movement of a ball on the underside is translated into direction signals),

optically (here identification of movement is implemented with the aid of a pair of LEDs and a special mouse mat with reflecting grid pattern) and

optomechanically (optical, two LED pairs with corresponding sensors, and mechanical means, rotatable perforated disks, are combined).

The so-called touchpad is a flat, rectangular tablet which uses touch-sensitive sensors to follow the position of a device on the surface of the tablet. The so-called trackball consists of a ball supported on two rollers. The rollers are arranged at right angles to one another and convert a movement of the ball into vertical and horizontal movements on the display screen. It usually has one or more keys for triggering other actions.

In general the input devices mentioned are well suited for position control. As, however, in general there is no linearly rising restoring-force, the path does not represent a measure for an introduced force. Thus forces introduced on to the device cannot be detected. Even less can introduced torques be detected, as rotation of the input device normally does not lead to any sort of drive signal. Moreover, there is also, of course, no restoring torque which allows the input device to return to a zero position again.

On the other hand force and moment sensors are known from the prior art which provide output signals in respect of a force and moment vector acting on them and thus output signals in respect of various degrees of freedom. They allow intuitive checking of real and virtual objects in up to 6 degrees of freedom (e.g. three translatory and three rotational degrees of freedom). Further degrees of freedom can be provided by switches, rotating wheels, etc., permanently allocated to the force and moment sensor. DE 199 52 560 A1 discloses a method for setting and/or adjusting the seat of a motor vehicle using a multi-functional input device, actuatable by hand, with a force and moment sensor. A force and moment sensor of this kind is illustrated in FIG. 6 of DE 199 52 560 A1. Thus far, therefore, in respect of the technical details of a sensor of this kind reference is made to this figure and the associated description for DE 199 52 560 A1. In DE 199 52 560 A1 the input device has an operating surface on which a number of areas for inputting at least one pressure pulse are provided. The input device has equipment for evaluating and identifying a pressure pulse detected by means of the force and moment sensor and converted into a force and moment vector pair. After selection of this kind, e.g. of a seat or part of a seat of a motor vehicle to be driven, the selected device can then be linearly driven by means of an analog signal of the force and moment sensor. Selection of a function and subsequent driving are therefore according to this prior art separated into two cycles separated chronologically from one another.

From DE 199 37 307 A1 it is known to use a force and moment sensor of this kind for controlling operating elements of a real or virtual mixing or control desk, for example to create and design new-style colour, light and/or sound compositions. The intuitive, spatial control can herein advantageously be transmitted in three translatory and three rotational grades of freedom for smooth, spatial mixing or controlling of a large number of optical and/or acoustic parameters. For control a pressure is exerted on the operating surface of the input device and thereby a pulse is generated which is detected with the aid of the force and moment sensor and converted into a vector pair consisting of one force and one moment vector. If certain characteristic pulse defaults are therein met, an object-specific control operation and/or a technical function can be triggered, for example, by switching into an activating state or terminated again by switching into a deactivating state.

To detect forces and moments the known force and moment sensors have an operating part which is supported as movable in three axes in respect of a base part, e.g. by means of springs or suchlike. The play of movement in each axis is therein normally restricted to a few millimetres. In practice it has proved that force and moment sensors are therefore poorly suited to position control.

Starting from the above-mentioned prior art in respect of position and force and moment sensors, the object of the present invention is to propose an input device for driving real or virtual objects which avoids the above-mentioned disadvantages.

This object is achieved according to the invention by the features of the independent claims. The dependent claims develop further the central idea of the invention in a particularly advantageous manner.

This object is achieved according to the invention in that the position and force and moment sensor is integrated in one device. This enables, for example, a certain position to be approached with the position sensor and then for drive signals dependent on force and/or moment to be output.

According to the invention the input device for driving virtual and/or real objects has a two-dimensional position sensor and a force and moment sensor which detects the forces and torques acting on the operating part of the force and moment sensor. By means of manual acting on the input device drive signals are triggered by the two-dimensional position sensor and/or the force and moment sensor.

The two-dimensional position sensor built in to the input device detects the position of the input device in respect of the base by means of equipment for detecting the movement direction (usually a ball).

Alternatively detection of the position can be done optically.

Particularly advantageous therein is an arch-shaped configuration of the housing of the input device. With this embodiment the device has two supporting faces with which in operation it rests on a base. The two-dimensional position sensor is integrated in one of these supporting faces.

The operating part of the force and moment sensor is attached to the underside of the arch-shaped housing of the input device. The force and moment sensor can therein be manipulated just with the fingertips of the user's hand, thereby avoiding excessive stress of the force and moment sensor.

During use of the input device the user's palm can conveniently rest on the housing. Alternatively the input device can have the form of a conventional computer mouse or be round or oval. The force and moment sensor is integrated on the upper side and the position sensor on the underside. It can be implemented in an optical, optomechanical or mechanical way.

If the input device has the above-mentioned computer mouse form, the force and moment sensor can alternatively be integrated at the side.

If the input device has the above-mentioned computer mouse form and the position sensor is on the underside, a force and moment sensor can be docked above or to the side. As the position sensor and force and moment sensor in this state form a physical unit, the assembled device can be operated by one hand.

However, it can alternatively be provided that the two-dimensional position sensor is integrated in the upper side of the operating part of the force and moment sensor.

In this case the two-dimensional position sensor can be implemented either by a touchpad or by a ball element. If a touchpad is used the movements of the finger on the pad are detected and evaluated as two-dimensional position information. In the case of the ball element (trackball) its rotation in respect of the operating part of the force and moment sensor is detected and evaluated as two-dimensional position information.

Alternatively, though, it can be provided that the operating part of the force and moment sensor can move freely on the two-dimensional position sensor. In this case the two-dimensional position sensor is implemented by a touchpad. The movements of the operating part of the force and moment sensor on the touchpad are detected and evaluated as two-dimensional position information.

Further features, advantages and properties of the present invention are now explained using embodiment examples and referring to the figures of the accompanying drawings.

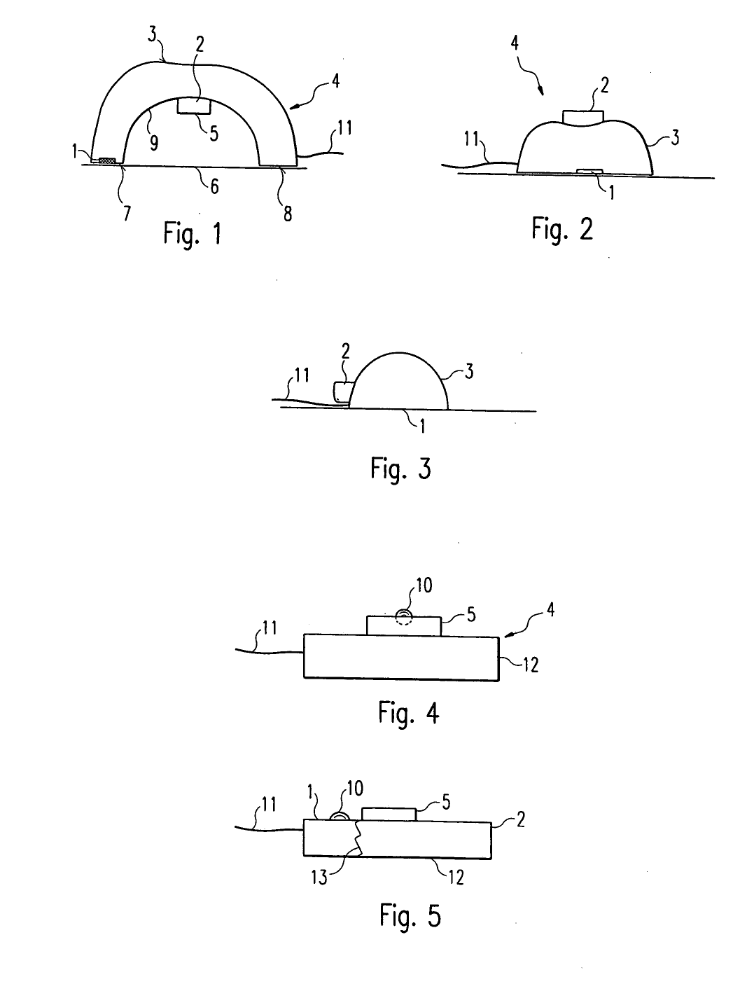

FIG. 1 therein shows an input device according to the invention in which a position sensor is integrated in the support face and the force and moment sensor is attached to the underside.

FIG. 2 shows an input device which has the form of a conventional computer mouse.

FIG. 3 shows a further input device which has the form of a conventional computer mouse.

FIG. 4 shows an input device in which the position sensor is integrated in the upper side of the operating part of the force and moment sensor.

FIG. 5 shows an arrangement in which the position sensor can be connected to the force and moment sensor by means of a detachable connection.

In the embodiment shown in FIG. 1 the housing of the input device 4 is constructed as substantially arch-shaped. As a result the input device 4 has two support faces 7, 8 with which it rests on a base 6. On the underside of one of these support faces, in the case shown support face 7, a two-dimensional position sensor 1 is integrated. It detects relative movements and thus the position of the input device 4 in respect of the base 6. This detection can be done optically, optomechanically or mechanically.

The force and moment sensor 2 is attached to the underside 9 of the arch-shaped input device 4. It has an operating part 5 which is supported as movable in several axes in respect of the housing of the input device 4. Owing to this special, protected attachment of the operating part 5 it can be manipulated just by the fingertips of one of the user's hands, wherein advantageously mechanical stress can be avoided. Practice has shown namely that there is a danger with force and moment sensors that resting the palm of the hand itself on them can move them as far as the stop and thus they are no longer capable of operating.

The force and moment sensor 2 detects the effects of forces and torques on the operating part 5 by means of the relative movement of the operating part 4 in three axes in respect of the housing of the input device 4. During use of the input device 4 the palm of the user's hand can rest conveniently on the upper side 3 of the housing of the input device 4.

The drive signals of the position sensor 1 and the force and moment sensor 2 can be forwarded to a computer, electronic or electrical devices by means of a cable 11 or an air interface (IR, electromagnetic, such as, e.g. according to the Bluetooth standard).

In the embodiment according to FIG. 2 the input device 4 has the form of a conventional computer mouse. The force and moment sensor 2 is therein attached to the upper side of the housing of a conventional computer mouse. The force and moment sensor 2 has been attached in such a way that it can easily be controlled with the fingers by pressing, pulling or rotating. During use of the input device 4 the palm of the user's hand can rest conveniently on the housing 3.

FIG. 3 shows a modification of the embodiment example of FIG. 2 to the effect that the force and moment sensor 2 is arranged on the front of the housing of a computer mouse 3, which again has the advantage that with normal handling of the computer mouse it is manipulated with the fingertips.

In the embodiment example according to FIG. 4 the two-dimensional position sensor 1 is integrated into the operating element 5 of the force and moment sensor 2. The two-dimensional position sensor 1 can be implemented either by a touchpad or, as illustrated, by a trackball 10. In the operating part 5 of the force and moment sensor the position drive signals are thus generated and forwarded to the base part 12 of the force and moment sensor.

In the embodiment example according to FIG. 5, finally, the two-dimensional position sensor 2 can be connected by means of a detachable connection, designated schematically as 13, to the force and moment sensor 2 and, more precisely, to the base part 12 of the force and moment sensor 2 to form a physical unit.

1-14. (Cancelled).

15. Input device for driving computers, electronic or electrical devices, having:
a two-dimensional position sensor and
a force and moment sensor, which detects forces and torques acting on an operating part of the force and moment sensor, wherein by manual manipulation of the input device drive signals are triggered by the two-dimensional position sensor and/or the force and moment sensor.

16. Input device according to claim 1, wherein the two-dimensional position sensor detects the position of the input device in respect of a base.

17. Input device according to claim 2, wherein the two-dimensional position sensor detects the position optically, optomechanically or mechanically.

18. Input device according to claim 1, wherein the input device is constructed as arch-shaped, so it can be placed with two support faces on a base, wherein the two-dimensional position sensor is located on one of the support faces of the input device.

19. Input device according to claim 4, wherein the force and moment sensor is located on the underside of the arch-shaped input device.

20. Input device according to claim 1, wherein the force and moment sensor is arranged on the input device in such a way that it cannot be directly manipulated with the palm of a user's hand, but only with the area of the fingertips of the user's hand.

21. Input device according to claim 6, wherein the force and moment sensor is covered in respect of direct contact with the palm of a user's hand.

22. Input device according to claim 1, wherein the force and moment sensor is placed on top of a two-dimensional position sensor in the form of a computer mouse.

23. Input device according to claim 1, wherein the force and moment sensor is integrated at the side of a two-dimensional position sensor in the form of a computer mouse.

24. Input device according to claim 1, wherein the force and moment sensor is integrated at the side of a two-dimensional position sensor in the form of a computer mouse.

25. Input device according to claim 1, wherein the two-dimensional position sensor is integrated into an upper side of the operating part of the force and moment sensor.

26. Input device according to claim 1, wherein the two-dimensional position sensor has a trackball which can be rotated by the user in respect of the operating part of the force and moment sensor, wherein this rotation is detected as two-dimensional position information.

27. Input device according to claim 1, wherein the two-dimensional position sensor is implemented by a touchpad.

28. Input device according to claim 1, wherein the position sensor is physically connected to the force and moment sensor by a detachable connection.
